(19) United States
(12) Patent Application Publication
(10) Pub. No.: US 2026/0170123 A1
(43) Pub. Date: Jun. 18, 2026

(54) TECHNIQUES FOR EXCHANGING OPERATING SYSTEMS AND DATA BETWEEN ENTITIES

(71) Applicant: QUALCOMM Incorporated, San Diego, CA (US)

(72) Inventors: Fabien COURTIADE, Ceyreste (FR); Raphael NAEFEN, Nyon (CH); Jerome PERRINE, Romanel sur Morges (CH); Asaf SHEN, Irvine, CA (US)

(21) Appl. No.: 18/984,838

(22) Filed: Dec. 17, 2024

(51) Int. Cl. G06F 21/53; G06F 21/57; G06F 21/62

(52) U.S. Cl. CPC G06F 21/53; G06F 21/57; G06F 21/6209

(57) ABSTRACT

Systems and techniques are provided for high assurance use cases. For instance, a process can include transmitting, to a secure element, a request to access an applet of the secure element based on a request received from an application executing within a high-level operating system (OS); receiving, from the secure element, a request to retrieve the applet from a portion of a first memory system; retrieving the applet from the first memory system; and providing the applet to the secure element for storage and execution within the secure element.

### FIELD

The present disclosure generally relates to secure computing. For example, aspects of the present disclosure relate to systems and techniques exchanging operating systems (OSs) and/or data between different entities.

### BACKGROUND

Computing devices typically store sensitive data owned by users or enterprises, with firmware or operating system software on the computing devices owned by a computing device or secure module manufacturer. To help increase security, the computing device may include hardware and/or software to help secure the computing device. As an example, a processor or system on chip (SoC) may include secure execution environments. A SoC may be single integrated circuit package that includes multiple components for a device, such as processor(s), memory, peripheral interfaces, graphics processors, etc. A secure execution environment may be an isolated processing environment (e.g., structure that includes components, either software or hardware, that may be accessed by software executing within the environment) for securely executing a process, application, software, etc. In some cases, these secure execution environments may have relatively limited computing resources as compared to a rich execution environment in which a high-level operating system (e.g., user facing operating systems such as Android, iOS, Windows, etc.) and/or applications may be executed. For example, a secure execution environment may have relatively limited amounts of storage. However, as the number of applications that can take advantage of a secure execution environment increases, the more likely the secure execution environment is to run into the limits of its computing resources. As enhancing the computing resources of the secure execution environment can be costly in terms of silicon area, redesign costs, etc. techniques for optimizing resource usage may be useful.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are systems, methods, apparatuses, and computer-readable media for performing delegated attestation. In one illustrative example, an apparatus for security is provided. The apparatus includes a secure element; a first memory system comprising instructions; and a processor system coupled to the first memory system and the secure element, wherein the secure element is configured to operate autonomously of the processor system, and wherein the processor system is configured to: transmit, to the secure element, a request to access an applet of the secure element based on a request received from an application executing within a high-level operating system (OS); receive, from the secure element, a request to retrieve the applet from a portion of the first memory system; retrieve the applet from the first memory system; and provide the applet to the secure element for storage and execution within the secure element.

As another example, a method for security is provided. The method includes: transmitting, to a secure element, a request to access an applet of the secure element based on a request received from an application executing within a high-level operating system (OS); receiving, from the secure element, a request to retrieve the applet from a portion of a first memory system; retrieving the applet from the first memory system; and providing the applet to the secure element for storage and execution within the secure element.

In another example, a non-transitory computer-readable medium having stored thereon instructions are provided. The instructions, when executed by at least one processor, cause the at least one processor to: transmit, to a secure element, a request to access an applet of the secure element based on a request received from an application executing within a high-level operating system (OS); receive, from the secure element, a request to retrieve the applet from a portion of a first memory system; retrieve the applet from the first memory system; and provide the applet to the secure element for storage and execution within the secure element.

As another example, an apparatus for security is provided. The apparatus includes: means for transmitting, to a secure element, a request to access an applet of the secure element based on a request received from an application executing within a high-level operating system (OS); means for receiving, from the secure element, a request to retrieve the applet from a portion of a first memory system; means for retrieving the applet from the first memory system; and means for providing the applet to the secure element for storage and execution within the secure element.

In some aspects, one or more of the apparatuses described herein is, is a part of, or includes a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device or system of a vehicle), or other device. In some aspects, the apparatus includes at least one camera for capturing one or more images or video frames. For example, the apparatus can include a camera (e.g., an RGB camera) or multiple cameras for capturing one or more images and/or one or more videos including video frames. In some aspects, the apparatus includes a display for displaying one or more images, videos, notifications, or other displayable data. In some aspects, the apparatus includes a transmitter configured to transmit one or more video frame and/or syntax data over a transmission medium to at least one device. In some aspects, the processor includes a neural processing unit (NPU), a central processing unit (CPU), a graphics processing unit (GPU), or other processing device or component.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware elements including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description.

### BRIEF DESCRIPTION OF THE DRAWINGS

Examples of various implementations are described in detail below with reference to the following figures:

FIG. 1 is a diagram illustrating an example wireless device, in accordance with some examples;

FIG. 2 is a block diagram illustrating an embedded secure element, in accordance with aspects of the present disclosure;

FIG. 3 is a block diagram illustrating a system for exchanging the OS and data between entities, in accordance with aspects of the present disclosure;

FIG. 4 is a flow diagram of a process for security, in accordance with aspects of the present disclosure;

FIG. 5 is a diagram illustrating an example of a computing system, according to aspects of the disclosure; and

FIG. 6 illustrates an example implementation of a system-on-a-chip (SOC), in accordance with some examples.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

In some cases, devices may include a secure element which includes layers of hardware security for performing sensitive operations, such as executing secure applications and storing confidential data associated with such applications. The secure element may be an isolated processing environment and the secure element may limit access to certain resources of the device, for example, to maintain security. In contrast, a high-level operating system may execute in a rich execution environment which has access to substantially all of the resources of the device. Examples of such secure applications (e.g., applets, may include cryptographic and/or security operations for a digital wallet, digital identification card, etc. As used herein, an applet may be a relatively lightweight software program for performing a security task. Applets may be relatively lightweight as compared to an application. In some cases, applet may not be able to execute independently of another application for running applets. Each applet and/or secure application may execute in an isolated environment and the data generated by and/or used by an applet may be contained within the isolated environment. Over time, this data may grow in size. Additionally, the applet may be updated and/or upgraded and may grow in size. Further, additional applets may be added to the secure element to support additional applications. However, the secure element may have a limited amount of storage space and techniques to optimize the storage space available may be useful.

Systems, apparatuses, electronic devices, methods (also referred to as processes), and computer-readable media (collectively referred to herein as “systems and techniques”) are described herein for exchanging OS and data between entities to help optimize the storage space of a secure element, such as an embedded secure element. In some cases, an embedded secure element may be a secure element embedded within hardware of a device. The device may include a first memory system and a processor system. The secure element may include a separate second memory system and the secure element may operate autonomously of the processor system of the device. A high-level OS may be executing on the processor system. A high-level OS may be a user facing OS, examples of which may include Android, iOS, Windows, etc. An application executing in the high-level OS may send a request to access to access an applet of the secure element. The applet of the secure element may be an applet that executes partially, or entirely, within the secure element. In some cases, the request to access the applet may be sent to a high assurance orchestrator agent executing on the processor system. The high assurance orchestrator agent may be a component for communicating with the secure element and for accessing a portion of the first memory system for the secure element.

Based on a request from the application, a request to access the applet of the secure element may be transmitted to the secure element. The secure element may determine that the applet is not stored in the second memory system (e.g., of the secure element) and the secure element may transmit a request to retrieve the applet from the portion of the first memory system (e.g., external storage, storage that is external to the secure element). The applet may then be retrieved from the first memory system and provided to the secure element for storage and execution within the secure element (e.g., to provide a response to the application executing in the high-level OS).

In some cases, the secure element may determine to store the applet to the first memory system. This determination may be based on a request to store the applet received from a component of the processing system or an application. The determination may also be based on an amount of space is available in the second memory system. The secure element may transmit a request to store the applet to the first memory system, for example, to the high assurance orchestrator agent, and the high assurance orchestrator agent may store the applet to the first memory system.

In some aspects, one or more of the apparatuses described herein comprises a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device of a vehicle), or other device. In some aspects, the apparatus(es) includes at least one camera for capturing one or more images or video frames. For example, the apparatus(es) can include a camera (e.g., an RGB camera) or multiple cameras for capturing one or more images and/or one or more videos including video frames. In some aspects, the apparatus(es) includes at least one display for displaying one or more images, videos, notifications, or other displayable data. In some aspects, the apparatus(es) includes at least one transmitter configured to transmit one or more video frame and/or syntax data over a transmission medium to at least one device. In some aspects, the at least one processor includes a neural processing unit (NPU), a neural signal processor (NSP), a central processing unit (CPU), a graphics processing unit (GPU), any combination thereof, and/or other processing device or component.

Additional aspects of the present disclosure are described in more detail below.

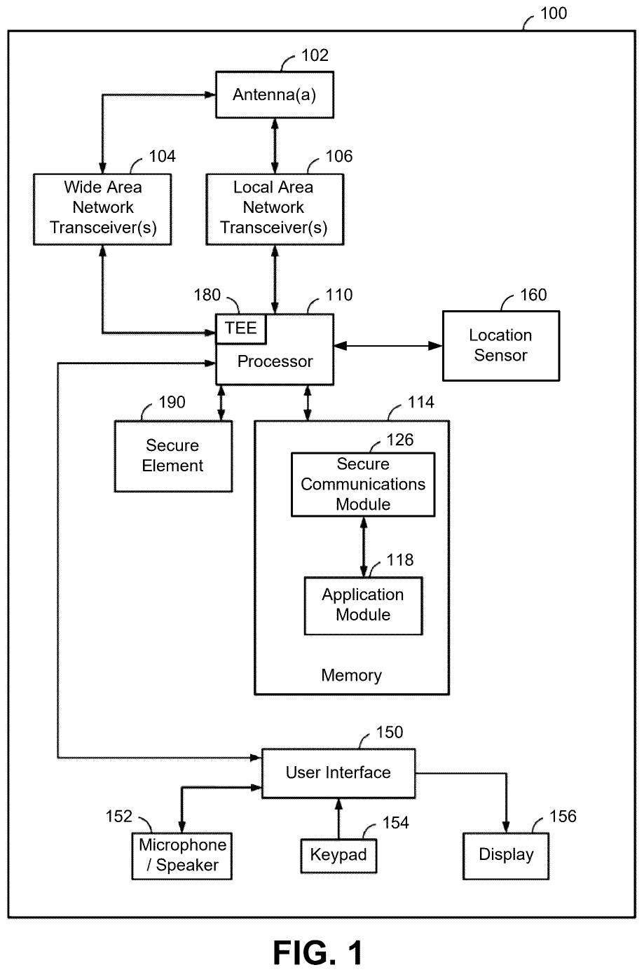

FIG. 1 is a diagram illustrating an example wireless device 100 that can be used to perform the techniques described herein. The wireless device 100 may include a client device such as a user equipment (UE) or other type of device (e.g., a station (STA) configured to communication using a Wi-Fi interface) that may be used by an end-user. For example, the wireless device 100 may include a mobile phone, a vehicle or computing system or device of the vehicle, a router, a tablet computer, a laptop computer, a tracking device, a wearable device (e.g., a smart watch, glasses, etc.), an extended reality (XR) device (e.g., a virtual reality (VR), augmented reality (AR), or mixed reality (MR) device, etc.), an Internet of Things (IoT) device, a access point, a point of sale device, and/or another device that is configured to communicate over a wireless communications network.

As shown, the wireless device 100 may include one or more local area network transceivers 106 that may be connected to one or more antennas 102. The one or more local area network transceivers 106 comprise suitable devices, circuits, hardware, and/or software for communicating with and/or detecting signals to/from a network device, and/or directly with other wireless devices, within a network.

The wireless device 100 may also include, in some implementations, one or more wide area network transceiver(s) 104 that may be connected to the one or more antennas 102. The wide area network transceiver 104 may comprise suitable devices, circuits, hardware, and/or software for communicating with and/or detecting signals from one or more other devices or systems and/or directly with other wireless devices within a network. In some implementations, the wide area network transceiver(s) 104 may comprise a CDMA communication system suitable for communicating with a CDMA network of wireless base stations. In some implementations, the wireless communication system may comprise other types of cellular telephony networks, such as, for example, TDMA, GSM, WCDMA, LTE, NR, and the like. Additionally, any other type of wireless networking technologies may be used, including, for example, WiMax (802.16), Wi-Fi (802.11), and the like.

The processor(s) (also referred to as a controller) 110 may be connected to the local area network transceiver(s) 106 and the wide area network transceiver(s) 104. The processor 110 may include one or more microprocessors, microcontrollers, and/or digital signal processors that provide processing functions, as well as other calculation and control functionality. The processor 110 may be coupled to storage media (e.g., memory) 114 for storing data and software instructions for executing programmed functionality within the mobile device. The memory 114 may be on-board the processor 110 (e.g., within the same IC package), and/or the memory may be external memory to the processor and functionally coupled over a data bus.

In some cases, the processor 110 may be coupled to a location sensor 160. The location sensor 160 may provide information regarding a location of the wireless device 100. In some cases, the location sensor 160 may include a Global Navigation Satellite System (GNSS) receivers or transceivers that are used to determine a location of the wireless device 100. In some cases, the location sensor 160 may estimate a location of the wireless device 100, for example, based on wireless signals received from one or more wireless nodes.

A number of software engines and data tables may reside in memory 114 and may be utilized by the processor 110 in order to manage both communications with remote devices/nodes, perform positioning determination functionality, and/or perform device control functionality. In some embodiments, the memory 114 may include an application engine 118 and a secure communications engine 126. It is to be noted that the functionality of the modules and/or data structures may be combined, separated, and/or be structured in different ways depending upon the implementation of the wireless device 100.

The application engine 118 may include a process running on the processor 110 of the wireless device 100, which may request data from one of the other modules of the wireless device 100. Applications typically run within an upper layer of the software architectures and may be implemented in a rich execution environment of the wireless device 100, and may include indoor navigation applications, shopping applications, financial services applications, social media applications, location aware service applications, etc. The applications of the application engine 118 may make use of access tokens to obtain content from a remote server.

The secure communications engine 126 may be a process configured to manage the storage of and access to the access tokens, encryption keys, attestation information, and the like. The secure communications engine 126 may be executed on a processor component of a trusted execution environment (TEE 180) and/or the secure element 190, where the wireless device 100 includes such components. The functionality of the secure communications engine 126 discussed herein can also be implemented as hardware or a combination of hardware and software. The secure communications engine 126 can be implemented one or more application specific integrated circuits (ASICs), programmable logic devices (PLDs), field programmable gate arrays (FPGAs), or other electronic units designed to perform the functions described herein, or a combination thereof.

The wireless device 100 may further include a user interface 150 providing suitable interface systems, such as a microphone/speaker 152, a keypad 154, and a display 156 that allows user interaction with the wireless device 100. The microphone/speaker 152 provides for voice communication services (e.g., using the wide area network transceiver(s) 104 and/or the local area network transceiver(s) 106). The keypad 154 may comprise suitable buttons for user input. The display 156 may include a suitable display, such as, for example, a backlit LCD display, and may further include a touch screen display for additional user input modes.

The processor 110 may also include a TEE 180. The TEE 180 can be implemented as a secure area of the processor 110 that can be used to process and store sensitive data in an environment that is segregated from the rich execution environment in which the operating system and/or applications (such as those of the application engine 118) may be executed. An example of a TEE may include an ARM TrustZone execution environment, which may execute authorized software known as “trusted application.” The TEE 180 can be configured to execute trusted applications that provide end-to-end security for sensitive data by enforcing confidentiality, integrity, and protection of the sensitive data stored therein. The TEE 180 can be used to store encryption keys, access tokens, and other sensitive data. In some cases, the TEE 180 may also be able to attest to the integrity of certain software executing on the wireless device 100. As used herein attestation is a process by which software executing on the wireless device 100 provides an assertion (e.g., information) to a relying party about the integrity of the wireless device 100. Examples for the assertion may include a hash of the application, a measurement of an operating system kernel, cryptographic function, security software, etc.

The wireless device 100 may include a secure element 190 (also referred to herein as a trusted component). The wireless device 100 may include the secure element 190 in addition to or instead of the TEE 180. The secure element 190 can comprise autonomous and tamper-resistant hardware that can be used to execute secure applications and the confidential data associated with such applications. For example, the secure element 190 or high assurance execution environment (e.g., secure processing unit), which may include an added layers of hardware security. The secure element 190 may be a secure execution environment separate from the TEE 180 and the secure element 190 may include more limited computing resources as compared to the TEE 180. In some cases, the secure element 190 can be external (e.g., on a separate IC package) to the processor 110 and/or SoC). For example, the secure element 190 can comprise a Near Field Communication (NFC) tag, a Subscriber Identity Module (SIM) card, or other type of hardware device that can be used to securely store data. The secure element 190 can be integrated (e.g., embedded) with the hardware of the wireless device 100 in a permanent or semi-permanent fashion or may, in some implementations, be a removable or external component of the wireless device 100 that can be used to securely store data and/or provide a secure execution environment for applications.

In some cases, to help reduce an attack surface against attacks, some secure applications may execute in a secure processing unit, such as the TEE 180 and/or secure element 190, without knowledge of other components in their operating environment, such as the wide/local area networks, sensors, such as the location sensor 160, and/or certain elements of the user interface, such as the microphone/speaker 152. In some cases, certain elements, such as the keypad 154 and/or display 156, may be needed by a secure application, for example, to provide a password to use a key to encrypt/decrypt data.

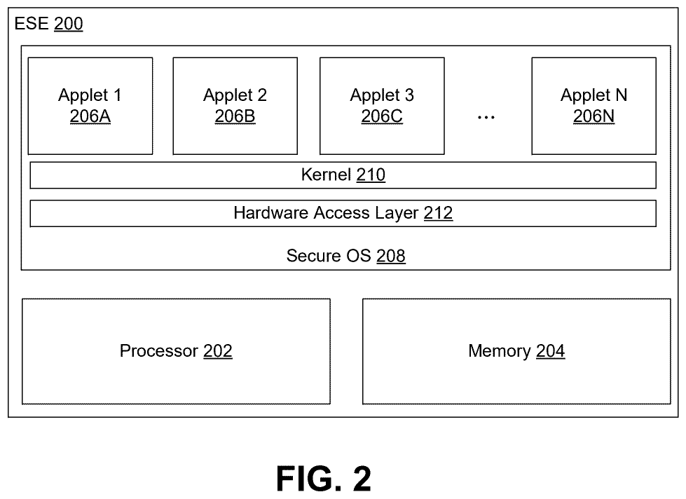

FIG. 2 is a block diagram illustrating an embedded secure element 200, in accordance with aspects of the present disclosure. In some cases, the embedded secure element 200 may be substantially similar to the secure element 190 of FIG. 1, and the embedded secure element 200 may be integrated with (e.g., embedded) with a device, such as wireless device 100. The embedded secure element 200 includes a processor 202 and memory 204.

The processor 202 may be computationally simpler as compared to a general purpose central processing unit (CPU) and the processor 202 may be configured to perform security tasks, such as encrypting/decrypting data, hashing, generating cryptographic keys, signing, etc. The processor 202 may execute verified and/or trusted applets, such as applet 1 206A, applet 2 206B, applet 3 206C, . . . applet N 206N (collectively “applets 206”) within a context of a secure OS 208, such as a Java Card OS. Applets may be a relatively lightweight software programs for performing a security task. In some cases, each applet may store data within the context of the applet. For example, the applets may execute in isolated environments and the data generated by and/or used by an applet may be contained within the isolated environment and not accessible to other applets. Applets 206 may be created by third parties and installed (e.g., written to) to the memory 204 for execution by the processor 202 via interfaces provided by the secure OS 208.

The secure OS 208 may provide interfaces for applets for accessing hardware resources of the embedded secure element 200, accessing/being accessed by other applications executing externally from the embedded secure element 200, and so forth. In some cases, the secure OS 208 may segregate applets 206 such that the applets 206 are executed in isolated environments (e.g., using Java Card virtual machines).

The secure OS 208 may include multiple layers such as a kernel 210 and a hardware access layer (HAL) 212. The kernel 210 may be a core of the secure OS 208 and the kernel 210 may provide various interfaces to services of the secure OS 208, such as interfaces for access to the hardware of the embedded secure element 200, communications interfaces, and the like. The HAL 212 may act as an interface between the secure OS 208 and the hardware of the embedded secure element 200 and the HAL 212 may be used to abstract the specific hardware of the embedded secure element 200 so that the secure OS 208 may have consistent interfaces to interact with different hardware devices. In some cases, the HAL 212 may be integrated with the kernel 210. Of note, the layers discussed herein are example layers and not intended to be limiting. The secure OS 208 may include additional layers or fewer (or no) layers.

The applets 206 and the secure OS 208 may be stored in the memory 204. The memory 204 may include volatile memory, such as RAM, SRAM, DRAM, etc., as well as non-volatile memory, such as EEPROM, flash memory, embedded nonvolatile memory (eNVM), etc.

Over time, more and more applets 206 may be created and/or updated to include additional features which may increase the amount of storage used by the applets 206. Additionally, existing applets 206 may continue to generate data, further increasing the amount of storage used by the applets 206. As a traditional embedded secure element, such as embedded secure element 200, may store the secure OS 208 along with the applets 206 and data, contexts, etc. generated and/or used by the applets 206 in the onboard memory 204, the traditional embedded secure element may be limited by an amount of storage space available in the memory 204.

While a shortage of available storage may be addressed by increasing a size of the memory 204, adding memory can be expensive with respect to the cost of additional memory, silicon area, physical space available for the embedded secure element 200, redesign time, etc. In some cases, it may be useful to utilize memory external to the embedded secure element 200 and swap (e.g., exchange) the secure OS and data between the memory 204 of the embedded secure element 200 and memory external to the embedded secure element 200.

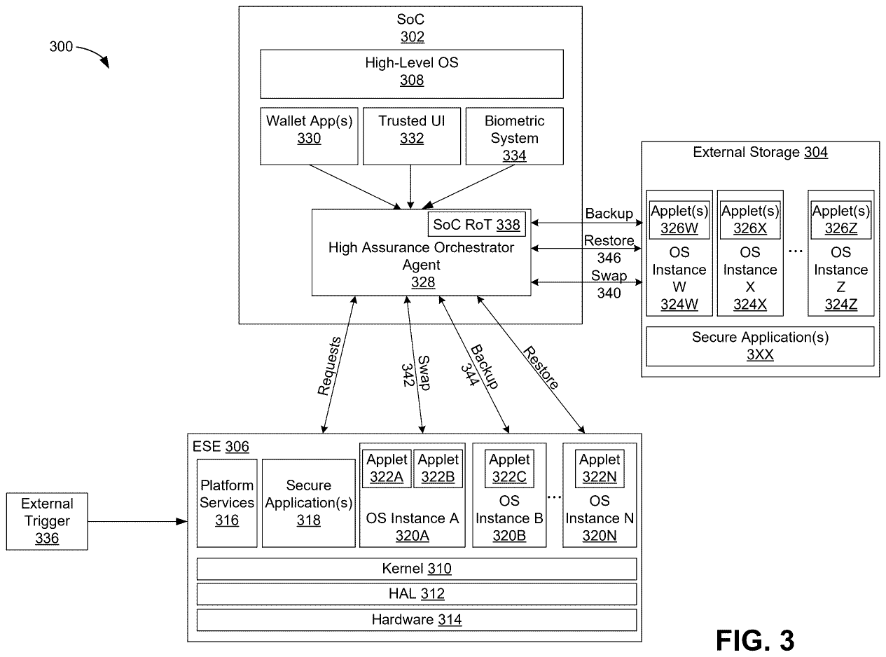

FIG. 3 is a block diagram illustrating a system for exchanging the OS and data between entities 300, in accordance with aspects of the present disclosure. FIG. 3 includes a SoC 302 electronically coupled to an external storage 304 and an embedded secure element 306. The embedded secure element 306 may be similar to secure element 190 of FIG. 1 and embedded secure element 200 of FIG. 2 with respect to hardware and/or physical implementation. In some cases, the embedded secure element 306 may include a split OS architecture. For example, the secure OS 208 of FIG. 2 may be split into a common part and an applet specific portion (e.g., OS instances, such as OS instance A 320A, OS instance B 320B, . . . , OS instance N 320N (collectively “OS instances 320”)). There may be any number of OS instances 320.

The common part may include a single version of services that may be used by multiple applets. A single version of common part may be provided by the embedded secure element 306. The common part executing on the embedded secure element 306 may include, for example, a kernel 310, a HAL 312 for accessing hardware 314, and platform services 316. In some cases, the HAL 312 may be substantially similar to the HAL 212 of FIG. 2. The hardware 314 may include the hardware components of the embedded secure element 306, such as a processor (e.g., processor 202 of FIG. 2), memory (e.g., memory 204 of FIG. 2), cryptographic hardware, hardware random number generator, etc. The hardware 314 may be accessible via interfaces provided by the HAL 312. In some cases, the platform services 316 may be split into a platform core services and platform extended services.

The common part may implement services that are typically/commonly used by applets, such as cryptographic services, memory management, drivers, etc. The common part may also implement services that are used by multiple applets, but may be less commonly used, such as loader services, install/uninstall services, and the like. In some cases, the platform services 316 may be able to dynamically load and/or unload specific applets 322 and OS instances 320 to address, for example, functional issues, security issues, etc. In some cases, the platform services 316 integrated with the kernel 310.

The kernel 310 may be a simplified version of the kernel 210 of FIG. 2 (e.g., micro-kernel). For example, the kernel 310 may primarily manage isolation of OS instances 320 stored and/or executing on the embedded secure element 306. In some cases, the kernel 310 may provide services for interacting with a native operating system (e.g., low-level host operating system specific the hardware) of the embedded secure element 306.

In some cases, applets (e.g., applet 322A, applet 322B, applet 322C, . . . , applet 322N, collectively “applets 322”) 322 may be integrated with specific OS instances 320. The applets 322 may be substantially similar to applets 206 of FIG. 2 and an applet of the applets 322 may also store data within the context of the applet itself. In some cases, multiple applets 322 may execute on a particular OS instance 320.

The OS instances 320 may include higher-level, applet specific services used to by specific applets and/or provide specific services to applets 322 integrated with an OS instance. For example, as indicated above, an applet, such as applet 322A, may be segregated (e.g., firewalled) from another applet, such as applet 322B of OS instance A 320A. Services for segregating the applets 322 (e.g., Java Card runtime environment, Java Card virtual machine, etc.) may be provided by the OS instances 320. The OS instances 320 may also provide applet facing interfaces (e.g., software interfaces, application programming interfaces (API)) that may be called by the applets 322. The non-applet facing interfaces of the OS instances 320 may call into common parts of the secure OS, such as the kernel 310, HAL 312, and/or platform services 316. The common parts of the secure OS may be stored in a memory of the embedded secure element 306 separate from the OS instances 320 (and integrated applets 322). The common parts of the secure OS may not be moved/stored in the external storage 304.

Each applet of the applets 322 may be integrated with an OS instance and multiple applets 322 (e.g., applet 322A and applet 322B) may be integrated with a specific OS instance (e.g., OS instance A 320A). In some cases, multiple applets 322 may be integrated with a specific OS instance when one applet has dependencies on another applet. Integrating an applet with the OS instance allows for greater segregation of the applets 322. For example, the embedded secure element 306 may execute each OS instance, along with applets integrated with the OS instance, independent of the other OS instances. Thus, OS instance A 320A (and applet 322A, applet 322B) may not be aware of, and execute independently of OS instance B 320B (and applet 322C). The common parts of the secure OS may handle conflicting resource requests from multiple OS instances 320. One OS instance (and integrated applets) may not be able to call into, load, or otherwise access another OS instance (and integrated applets). Each OS instance, along with integrated applets, may be stored independently of other OS instances.

In some cases, a first OS instance may differ from a second OS instance. For example, OS instance A 320A may be a different version of the OS instance as compared to OS instance B 320B. As another example, the first OS instance may be customized for the services used by applets executing in the first OS instance and the second OS instance may be customized for the services used by applets executing in the second OS instance. As a more specific example, the applet 322A and applet 322B may be used for a payment system and OS instance A 320A may include a set of services typically used by payment systems, while applet 322C may be used for a digital identity service and may include a set of services typically used for identity services, which may differ from the set of services typically used by payment systems.

The external storage 304 may be a portion of a storage system generally accessible to the SoC 302, such as storage media (e.g., non-volatile memory, such as EEPROM, flash memory, embedded nonvolatile memory (eNVM), etc.) and/or memory (e.g., volatile memory, such as RAM, SRAM, DRAM, etc.) of the device (e.g., memory 114 of FIG. 1). In some cases, the external storage 304 may include off-device storage, such as network storage, cloud storage, decentralized storage, etc. As an example of general accessibility of the storage system, user applications executing within a context of a high-level OS 308 may also be able to access certain portions of the storage system. In some cases, one or more portions of the storage system may be allocated for use as the external storage 304 for the embedded secure element 306. In some cases, the external storage 304 may be controlled by the high assurance orchestrator agent 328. Access to the external storage 304 may be restricted to the high assurance orchestrator agent 328 and the high assurance orchestrator agent 328 may provide access to the external storage 304 to the embedded secure element 306.

In some cases, the external storage 304 may also be used to store OS instances (e.g., OS instance W 324W, OS instance X 324X, . . . , OS instance Z 324Z, collectively “stored OS instances 324”) along with their integrated applets (e.g., applet 326W, applet 326X, . . . , applet 326Z, collectively “stored applets 326”). The stored OS instances 324 and stored applets 326 may be substantially similar to OS instances 320 and applets 322, respectively. In some cases, the OS instances 320, stored OS instances 324, applets 322, and stored applets 326 may be managed by a high assurance orchestrator agent 328 of the SoC 302.

The SoC 302 may include, among other components, the high assurance orchestrator agent 328. In some cases, the high-level OS 308 may execute on processor(s) (not shown) of the SoC 302, independent of the embedded secure element 306. In some cases, the SoC 302 may include various components that may interact with the applets 322 of the embedded secure element 306. Examples of these components that may interact with the applets 322 may include one or more wallet apps 330, trusted user interface(s)(UI) 332, and/or a biometric system 334 via the high assurance orchestrator agent 328. For example, the wallet app 330 may call the high assurance orchestrator agent 328 to interact with one or more applets, such as applet 322A and/or applet 322B of OS instance A 320A. The high assurance orchestrator agent 328 may ensure that OS instance A 320A is loaded (e.g., stored, made available, etc.) in a memory (e.g., of hardware 314) of the embedded secure element 306 so that operations of applet 322A and applet 322B may be performed by the embedded secure element 306. Once the correct OS instance (e.g., OS instance A 320A) is available in the embedded secure element 306, the high assurance orchestrator agent 328 may indicate to the wallet app 330 that applet 322A and/or applet 322B are available. In some cases, the components that may interact with the applets 322 may execute within the high-level OS 308, or may be associated with other components that execute within the high-level OS 308.

As indicated above, the high assurance orchestrator agent 328 may manage storage and/or availability of the applets 322 and stored applets 326 to the embedded secure element 306. In some cases, the high assurance orchestrator agent 328 may determine whether a requested applet is available (e.g., stored in) to the embedded secure element 306. Applets (e.g., stored applets 326) executable by the embedded secure element 306 may be stored on the external storage 304 and the high assurance orchestrator agent 328 may coordinate swapping 340 (e.g., loading) a stored applet from the external storage 304 to the memory of the embedded secure element 306. The high assurance orchestrator agent 328 may also coordinate swapping 342 an applet from the memory of the embedded secure element 306 to the external storage 304. For example, the trusted UI 332 may transmit a request to the high assurance orchestrator agent 328 to access stored applet 326X. The high assurance orchestrator agent 328 may determine that the applet 326X is stored in external storage 304. In some cases, the high assurance orchestrator agent 328 may track where applets and associated OS instances are stored, for example in a table, list, database, etc. In such cases, the high assurance orchestrator agent 328 may send a request to the embedded secure element 306 for the applet 326X along with an indication of where the applet 326X is stored. Alternatively, the high assurance orchestrator agent 328 may indicate, for example, to the trusted UI 332 the location of the applet 326X and the trusted UI 332 (or another process) may send a request to the embedded secure element 306 for the applet 326X along with an indication of where the applet 326X is stored as an external trigger 336. In other cases, the embedded secure element 306 may track where applets and associated OS instances are stored and the high assurance orchestrator agent 328 may either query the embedded secure element 306 to determine where the applet 326X is stored or attempt to access the applet 326X (or associated OS instance X 324X).

In response to a request to access (or retrieve) the applet 326X, the embedded secure element 306 may verify the security of the high assurance orchestrator agent 328, SoC 302, and/or the external storage 304. For example, the high assurance orchestrator agent 328 may include a root of trust (RoT) 338. The RoT 338 may be used to verify the security of the SoC 302 and external storage 304 and establish a security boundary for the SoC 302 and external storage 304. The security boundary may refer to hardware and/or software that forms a trusted zone or boundary and provides the basis for performing security services. The security boundary established by the hardware and/or software may present a boundary that is not easily bypassed/compromised by an attacker and the hardware and/or software establishing the security boundary may verify that other hardware/software used/executing within the security boundary is trusted. The RoT 338 may attest regarding the integrity of the hardware and/or software of the SoC 302 and the external storage 304 to the embedded secure element 306. As used herein attestation may be a process by which software executing on a device provides an assertion (e.g., information) about the integrity of the platform (e.g., SoC 302 and the external storage 304). Examples for the assertion may include a hash of the application, a measurement of an operating system kernel, cryptographic function, security software, etc., or a measurement of another software/hardware component of the device. If the attestation provided by the RoT is sufficient, the embedded secure element 306 may initiate swapping 340 (e.g., copying, moving, etc.) the OS instance X 324X and applet 326X from the external storage 304 to a memory of the embedded secure element 306. The embedded secure element 306 may then notify the high assurance orchestrator agent 328 and/or trusted UI 332 that the applet 326X is available.

In some cases, the embedded secure element 306 may also swap 342 an applet from the memory of the embedded secure element 306 to the external storage 304. For example, if the memory of the embedded secure element 306 is full or nearly full, the embedded secure element 306 may move an applet and associated OS instance from the memory of the embedded secure element 306 to the external storage 304. In some cases, the embedded secure element 306 may verify the security of the high assurance orchestrator agent 328, SoC 302, and/or the external storage 304 in a manner substantially similar to that described above and move the applet and associated OS instance to the external storage 304.

In some cases, the embedded secure element 306 may backup 344 an applet from the memory of the embedded secure element 306 to the external storage 304. For example, the embedded secure element 306 may receive a request to backup an applet (and associated OS instance) from the high assurance orchestrator agent 328 or from the components that may interact with the applets 322. The embedded secure element 306 may then verify the security of the high assurance orchestrator agent 328, SoC 302, and/or the external storage 304 in a manner substantially similar to that described above and copy the applet (and associated OS instance) to the embedded secure element 306. In some cases, the backed-up applets may be used, for example, to migrate applets to another device (e.g., if the user upgrades to a new device).

In some cases, the embedded secure element 306 may restore 346 an applet from the external storage 304 to the memory of the embedded secure element 306. In some cases, restoring 346 an app may be substantially similar to swapping 340) a stored applet from the external storage 304 to the memory of the embedded secure element 306 as discussed above.

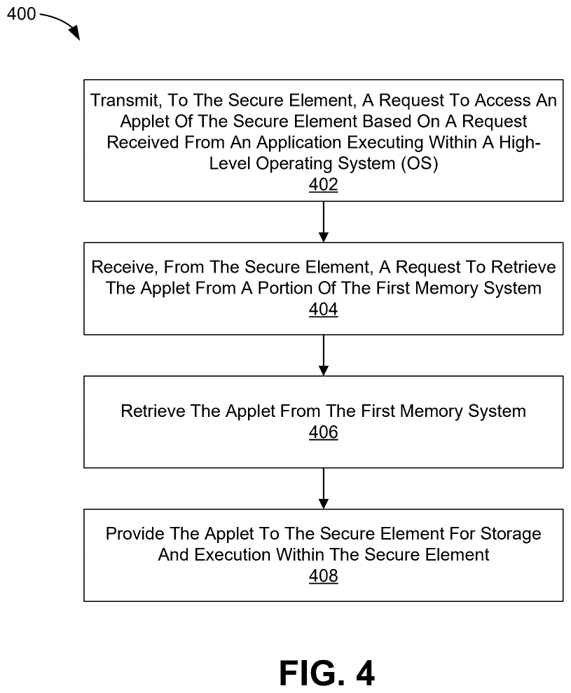

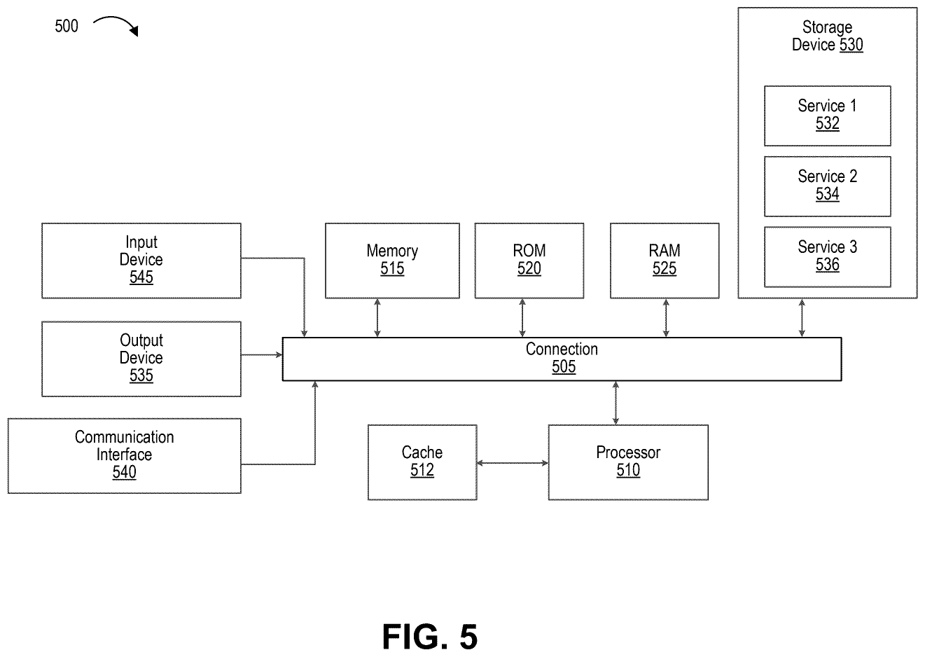

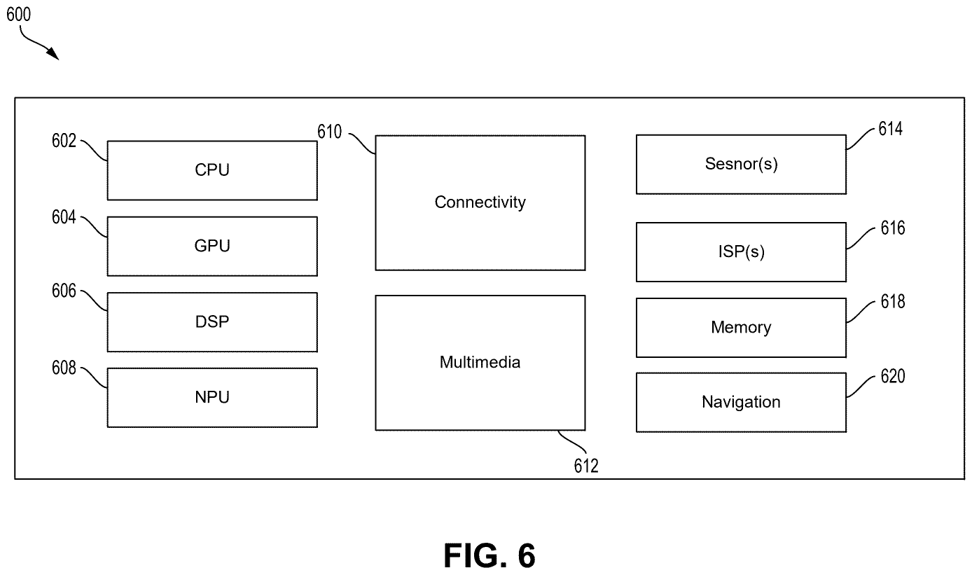

FIG. 4 is a flow diagram of a process 400 for security, in accordance with aspects of the present disclosure. The process 400 may be performed by a computing device (or apparatus) or a component (e.g., a chipset, codec, processor 110 of FIG. 1, TEE 180 of FIG. 1, secure element 190 of FIG. 1, embedded secure element 200 of FIG. 2, SoC 302 of FIG. 3, ESE 306 of FIG. 3, external storage 304 of FIG. 3, processor 510 of FIG. 5, SOC 600 of FIG. 6, etc.) of the computing device. Examples of the computing device can include the wireless device 100 of FIG. 1, computing system 500 of FIG. 5. The computing device may be a mobile device (e.g., a mobile phone), an extended reality (XR) device such as a virtual reality (VR) device or augmented reality (AR) device, a vehicle or component or system of a vehicle, a network-connected wearable such as a watch, or other type of computing device. In another example, the process 400 may be performed by a computing device with the computing system 500 shown in FIG. 5. The operations of the process 400 may be implemented as software components that are executed and run on one or more processors. In some cases, the computing device may include an indication, such as a configuration, that the UE may use an enhanced privacy technique, such as techniques discussed in accordance with aspects of the present disclosure.

At block 402, the computing device (or component thereof) may transmit, to the secure element, a request to access an applet (e.g., applets 326 of FIG. 3) of the secure element based on a request received from an application executing within a high-level operating system (OS) (e.g., high-level OS 308 of FIG. 3). The computing device may include a secure element (e.g., secure element 190 of FIG. 1, ESE 200 of FIG. 2, ESE 306 of FIG. 3, etc.) where the secure element operates autonomously of the processor system. In some cases, the applet is integrated with an instance of a secure OS (e.g., OS instances 320 of FIG. 3, OS instances 324 of FIG. 3, etc.), wherein the instance of the secure OS is separate from the high-level OS. In some examples, the instance of the secure OS includes interfaces for use by the applet. In some examples, the instance of the secure OS is configured to interface with a common part of the secure OS (e.g., kernel 310 of FIG. 3, HAL 312 of FIG. 3, etc.) stored in a second memory system of the secure element, wherein the applet executes within the instance of the secure OS, and wherein the common part of the secure OS is separate from the instance of the secure OS. In some cases, the common part of the secure OS comprises at least one of a kernel or a hardware access layer. In some examples, multiple applets (e.g., applet 322A and 322B of FIG. 3) are integrated within the instance of the secure OS.

At block 404, the computing device (or component thereof) may receive, from the secure element, a request to retrieve the applet from a portion of the first memory system (e.g., external storage 304 of FIG. 3). In some cases, the computing device (or component thereof) may include a high assurance orchestrator agent (e.g., high assurance orchestrator agent 328 of FIG. 3) for communicating with the secure element and accessing the portion of the first memory system, and wherein the secure element accesses the portion of the first memory system via the high assurance orchestrator agent. In some examples, the high assurance orchestrator agent includes a root of trust (e.g., SoC RoT 338 of FIG. 3) for verifying security of the portion of the first memory system.

At block 406, the computing device (or component thereof) may retrieve the applet from the first memory system.

At block 408, the computing device (or component thereof) may provide the applet to the secure element for storage and execution within the secure element. In some cases, the computing device (or component thereof) may receive, from the secure element, a request to store the applet to the first memory system; and store the applet to the first memory system. In some examples, the computing device (or component thereof) may receive, from the secure element, a request to store the applet to the first memory system; and store the applet to the first memory system. In some cases, the request to store the applet to the first memory system was sent by the secure element in response to a request to store the applet received by the secure element

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data.

The computing device may further include a network interface, transceiver, and/or transmitter configured to communicate the video data. The network interface, transceiver, and/or transmitter may be configured to communicate Internet Protocol (IP) based data or other network data. The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 400 and/or other processes described herein may include a processor, microprocessor, micro-computer, or other component of a device that is configured to carry out the steps of the process 400 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 400 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 400 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 400 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 5 is a diagram illustrating an example of a system for implementing certain aspects of the present technology. In particular, FIG. 5 illustrates an example of computing system 500, which may be for example any computing device making up internal computing system, a remote computing system, a camera, or any component thereof in which the components of the system are in communication with each other using connection 505. Connection 505 may be a physical connection using a bus, or a signal connection into processor 510, such as in a chipset architecture. Connection 505 may also be a virtual connection, networked connection, or logical connection.

In some embodiments, computing system 500 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 500 includes at least one processing unit (CPU or processor) 510 and connection 505 that communicatively couples various system components including system memory 515, such as read-only memory (ROM) 520 and random access memory (RAM) 525 to processor 510. Computing system 500 may include a cache 512 of high-speed memory connected directly with, in close proximity to, or integrated as part of processor 510.

Processor 510 may include any general purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which may represent any number of input mechanisms, such as a microphone for speech, a touch-sensitive screen for gesture or graphical input, keyboard, mouse, motion input, speech, etc. Computing system 500 may also include output device 535, which may be one or more of a number of output mechanisms. In some instances, multimodal systems may enable a user to provide multiple types of input/output to communicate with computing system 500.

Computing system 500 may include communications interface 540, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 540 may also include one or more Global Navigation Satellite System (GNSS) receivers or transceivers that are used to determine a location of the computing system 500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 530 may be one or more non-volatile and/or non-transitory and/or computer-readable memory devices and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1(L 1 ) cache, Level 2(L 2 ) cache, Level 3(L 3 ) cache, Level 4(L 4 ) cache, Level 5(L 5 ) cache, or other (L#) cache), resistive random-access memory (RRAM/ReRAM), phase change memory (PCM), spin transfer torque RAM (STT-RAM), another memory chip or cartridge, and/or a combination thereof.

The storage device 530 may include software services, servers, services, etc., that when the code that defines such software is executed by the processor 510, it causes the system to perform a function. In some embodiments, a hardware service that performs a particular function may include the software component stored in a computer-readable medium in connection with the necessary hardware components, such as processor 510, connection 505, output device 535, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

FIG. 6 illustrates an example implementation of a SOC 600, which may include a central processing unit (CPU) 602 or a multi-core CPU, configured to perform one or more of the functions described herein. In some cases, SOC 600 may include aspects discussed with respect to SoC 302 of FIG. 3. Parameters or variables (e.g., neural signals and synaptic weights), system parameters associated with a computational device (e.g., neural network with weights), delays, frequency bin information, task information, among other information may be stored in a memory block associated with a neural processing unit (NPU) 608, in a memory block associated with a CPU 602, in a memory block associated with a graphics processing unit (GPU) 604, in a memory block associated with a digital signal processor (DSP) 606, in a memory block 618, and/or may be distributed across multiple blocks. Instructions executed at the CPU 602 may be loaded from a program memory associated with the CPU 602 or may be loaded from a memory block 618.

The SOC 600 may also include additional processing blocks tailored to specific functions, such as a GPU 604, a DSP 606, a connectivity block 610, which may include fifth generation (5G) connectivity, fourth generation long term evolution (4G LTE) connectivity, Wi-Fi connectivity, USB connectivity, Bluetooth connectivity, and the like, and a multimedia processor 612 that may, for example, detect and recognize gestures. In one implementation, the NPU is implemented in the CPU 602, DSP 606, and/or GPU 604. The SOC 600 may also include one or more sensors 614, image signal processors (ISPs) 616, and/or navigation module 620, which may include a global positioning system.

The SOC 600 may be based on an ARM instruction set. SOC 600 and/or components thereof may be configured to perform segmentation mask extrapolation. For example, the CPU 602, DSP 606, and/or GPU 604 may be configured to perform object detection using a visual language model via latent feature adaptation with synthetic data.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed by one or more processors, performs one or more of the methods, algorithms, and/or operations described above. The computer-readable data storage medium may form part of a computer program product, which may include packaging materials. The computer-readable medium and/or memory system may comprise any memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, memory 615, read-only memory (ROM) 620, random access memory (RAM) 625, storage device 630, and the like, and the computer-readable medium may include multiple memories or data storage media. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor system, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor system may be configured to perform any of the techniques described in this disclosure. A general-purpose processor may be a microprocessor; but in the alternative, the processor may be any conventional processor, controller, microcontroller, or state machine. A processor system may also be implemented as a combination of computing devices, e.g., a combination of a DSP and a microprocessor, a plurality of microprocessors, one or more microprocessors in conjunction with a DSP core, or any other such configuration. Accordingly, the term “processor system,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:
Aspect 1. An apparatus for security, comprising: a secure element; a first memory system comprising instructions; and a processor system coupled to the first memory system and the secure element, wherein the secure element is configured to operate autonomously (e.g., the secure element operates autonomously) of the processor system, and wherein the processor system is configured to: transmit, to the secure element, a request to access an applet of the secure element based on a request received from an application executing within a high-level operating system (OS); receive, from the secure element, a request to retrieve the applet from a portion of the first memory system; retrieve the applet from the first memory system; and provide the applet to the secure element for storage and execution within the secure element.
Aspect 2. The apparatus of Aspect 1, wherein the applet is integrated with an instance of a secure OS, wherein the instance of the secure OS is separate from the high-level OS.
Aspect 3. The apparatus of Aspect 2, wherein the instance of the secure OS includes interfaces for use by the applet.
Aspect 4. The apparatus of Aspect 3, wherein the instance of the secure OS is configured to interface with a common part of the secure OS stored in a second memory system of the secure element, wherein the applet executes within the instance of the secure OS, and wherein the common part of the secure OS is separate from the instance of the secure OS.
Aspect 5. The apparatus of Aspect 4, wherein the common part of the secure OS comprises at least one of a kernel or a hardware access layer.
Aspect 6. The apparatus of any of Aspects 2-5, wherein multiple applets are integrated within the instance of the secure OS.
Aspect 7. The apparatus of any of Aspects 1-6, wherein the processor system includes a high assurance orchestrator agent for communicating with the secure element and accessing the portion of the first memory system, and wherein the secure element accesses the portion of the first memory system via the high assurance orchestrator agent.
Aspect 8. The apparatus of Aspect 7, wherein the high assurance orchestrator agent includes a root of trust for verifying security of the portion of the first memory system.
Aspect 9. The apparatus of any of Aspects 1-8, wherein the processor system is further configured to: receive, from the secure element, a request to store the applet to the first memory system; and store the applet to the first memory system.
Aspect 10. The apparatus of Aspect 9, wherein the request to store the applet to the first memory system was sent by the secure element in response to a request to store the applet received by the secure element.
Aspect 11. A method for security, comprising: transmitting, to a secure element, a request to access an applet of the secure element based on a request received from an application executing within a high-level operating system (OS); receiving, from the secure element, a request to retrieve the applet from a portion of a first memory system; retrieving the applet from the first memory system; and providing the applet to the secure element for storage and execution within the secure element.
Aspect 12. The method of Aspect 11, wherein the applet is integrated with an instance of a secure OS, wherein the instance of the secure OS is separate from the high-level OS.
Aspect 13. The method of Aspect 12, wherein the instance of the secure OS includes interfaces for use by the applet.
Aspect 14. The method of Aspect 13, wherein the instance of the secure OS is configured to interface with a common part of the secure OS stored in a second memory system of the secure element, wherein the applet executes within the instance of the secure OS, and wherein the common part of the secure OS is separate from the instance of the secure OS.
Aspect 15. The method of Aspect 14, wherein the common part of the secure OS comprises at least one of a kernel or a hardware access layer.
Aspect 16. The method of any of Aspects 12-15, wherein multiple applets are integrated within the instance of the secure OS.
Aspect 17. The method of any of Aspects 11-16, further comprising a high assurance orchestrator agent for communicating with the secure element and accessing the portion of the first memory system, and wherein the secure element accesses the portion of the first memory system via the high assurance orchestrator agent.
Aspect 18. The method of Aspect 17, wherein the high assurance orchestrator agent includes a root of trust for verifying security of the portion of the first memory system.
Aspect 19. The method of any of Aspects 11-18, further comprising: receiving, from the secure element, a request to store the applet to the first memory system; and storing the applet to the first memory system.
Aspect 20. The method of Aspect 19, wherein the request to store the applet to the first memory system was sent by the secure element in response to a request to store the applet received by the secure element.
Aspect 21. A non-transitory computer-readable medium having stored thereon instructions that, when executed by at least one processor, cause the at least one processor to perform operations according to any of Aspects 11-20.
Aspect 22. An apparatus for security, comprising one or more means for performing operations according to any of Aspects 11-20.

What is claimed is:

1. An apparatus for security, comprising:
a secure element;
a first memory system comprising instructions; and
a processor system coupled to the first memory system and the secure element, wherein the secure element is configured to operate autonomously of the processor system, and wherein the processor system is configured to:
transmit, to the secure element, a request to access an applet of the secure element based on a request received from an application executing within a high-level operating system (OS);
receive, from the secure element, a request to retrieve the applet from a portion of the first memory system;
retrieve the applet from the first memory system; and
provide the applet to the secure element for storage and execution within the secure element.

2. The apparatus of claim 1, wherein the applet is integrated with an instance of a secure OS, wherein the instance of the secure OS is separate from the high-level OS.

3. The apparatus of claim 2, wherein the instance of the secure OS includes interfaces for use by the applet.

4. The apparatus of claim 3, wherein the instance of the secure OS is configured to interface with a common part of the secure OS stored in a second memory system of the secure element, wherein the applet executes within the instance of the secure OS, and wherein the common part of the secure OS is separate from the instance of the secure OS.

5. The apparatus of claim 4, wherein the common part of the secure OS comprises at least one of a kernel or a hardware access layer.

6. The apparatus of claim 2, wherein multiple applets are integrated within the instance of the secure OS.

7. The apparatus of claim 1, wherein the processor system includes a high assurance orchestrator agent for communicating with the secure element and accessing the portion of the first memory system, and wherein the secure element accesses the portion of the first memory system via the high assurance orchestrator agent.

8. The apparatus of claim 7, wherein the high assurance orchestrator agent includes a root of trust for verifying security of the portion of the first memory system.

9. The apparatus of claim 1, wherein the processor system is further configured to:
receive, from the secure element, a request to store the applet to the first memory system; and
store the applet to the first memory system.

10. The apparatus of claim 9, wherein the request to store the applet to the first memory system was sent by the secure element in response to a request to store the applet received by the secure element.

11. A method for security, comprising:
transmitting, to a secure element, a request to access an applet of the secure element based on a request received from an application executing within a high-level operating system (OS);
receiving, from the secure element, a request to retrieve the applet from a portion of a first memory system;
retrieving the applet from the first memory system; and
providing the applet to the secure element for storage and execution within the secure element.

12. The method of claim 11, wherein the applet is integrated with an instance of a secure OS, wherein the instance of the secure OS is separate from the high-level OS.

13. The method of claim 12, wherein the instance of the secure OS includes interfaces for use by the applet.

14. The method of claim 13, wherein the instance of the secure OS is configured to interface with a common part of the secure OS stored in a second memory system of the secure element, wherein the applet executes within the instance of the secure OS, and wherein the common part of the secure OS is separate from the instance of the secure OS.

15. The method of claim 14, wherein the common part of the secure OS comprises at least one of a kernel or a hardware access layer.

16. The method of claim 12, wherein multiple applets are integrated within the instance of the secure OS.

17. The method of claim 11, further comprising a high assurance orchestrator agent for communicating with the secure element and accessing the portion of the first memory system, and wherein the secure element accesses the portion of the first memory system via the high assurance orchestrator agent.

18. The method of claim 17, wherein the high assurance orchestrator agent includes a root of trust for verifying security of the portion of the first memory system.

19. The method of claim 11, further comprising:
receiving, from the secure element, a request to store the applet to the first memory system; and
storing the applet to the first memory system.

20. The method of claim 19, wherein the request to store the applet to the first memory system was sent by the secure element in response to a request to store the applet received by the secure element.
